(19) United States
(12) Patent Application Publication
(10) Pub. No.: US 2012/0082553 A1
(43) Pub. Date: Apr. 5, 2012

(54) METAL ENCAPSULATED STATOR VANE

(76) Inventors: Andreas Eleftheriou, Woodbridge (CA); Barry Barnett, Markham (CA); Joe Lanzino, Orangeville (CA); Tom McDonough, Barrie (CA); George Guglelmin, Toronto (CA); Enzo Macchia, Kleinburg (CA); Melinda Bissinger, Mississauga (CA)

(21) Appl. No.: 13/189,059

(22) Filed: Jul. 22, 2011

Related U.S. Application Data
(60) Provisional application No. 61/388,378, filed on Sep. 30, 2010.

(51) Int. Cl. F01D 5/14; B23P 15/02

(52) U.S. Cl. 416/224; 29/889.7

(57) ABSTRACT

A hybrid vane airfoil for a gas turbine engine, such as a vane of a compressor stator, is disclosed which includes a non-metallic core, and an outer metallic shell at least partially covering the non-metallic core and which defines an outer surface of the airfoil. The non-metallic core is composed for example of a polymer, and the metallic outer shell is composed of a nanocrystalline metallic coating.

### CROSS-REFERENCE TO RELATED APPLICATIONS

The present application claims priority on U.S. Provisional Patent Application No. 61/388,378 filed Sep. 30, 2010, the entire contents of which is incorporated herein by reference.

### TECHNICAL FIELD

The application relates generally to gas turbine engines, and more particular to components, such as airfoils, used in such gas turbine engines.

### BACKGROUND

Compressor vanes and other airfoils in aero gas turbine engines are generally designed to have low maintenance costs. This is typically achieved by: designing the vane to be field replaceable; designing the vane such that repair is as simple as possible; and designing the vane such that it is so robust that it is not prone to foreign object damage (FOD) and erosion and consequently sees little damage in the field. Usually, gas turbine vanes are manufactured from aluminum, steel or from non-metallic materials such as carbon fiber composites. Typically the airfoil shapes have been relatively simple, enabling vanes to be manufactured from simple metal forming methods and using simple materials, such as solid aluminum. Complex vane shapes may be desired but manufacturing of these from solid metal would be costly and difficult. More recently, such vanes have been made of carbon fiber composite through resin transfer molding, to accommodate more complex vane geometries. However, the cost and lead times of manufacturing a carbon fiber vane is significantly increased when compared to simple forged stampings that were used in earlier gas turbine engines.

Accordingly, improvements are desirable.

### SUMMARY

In accordance with one aspect of the present disclosure, there is provided a compressor stator for a gas turbine engine, the stator comprising: a plurality of hybrid vanes each including an airfoil extending between a vane root and a vane tip; and each of the hybrid vanes having a core of a non-metallic substrate at least partially covered by a nanocrystalline metal shell, the nanocrystalline metal shell defining an outer surface of the vane.

In accordance with another aspect of the present disclosure, there is also provided a hybrid vane airfoil for a compressor stator in gas turbine engine, the hybrid vane airfoil comprising a bi-material structure having a polymer core that is encapsulated by a metallic shell defining an outer surface of the vane, the metallic shell having at least an outer surface entirely composed of a nanocrystalline metal having an average grain size of between 10 nm and 500 nm, and the metallic shell having a thickness of between 0.001 inch and 0.008 inch.

There is further provided, in accordance with another aspect of the present disclosure, a method of manufacturing a vane for a gas turbine engine, comprising: forming a non-metallic airfoil out of a polymer, to form a polymer core; and applying a coating of nanocrystalline metal onto the polymer core, the nanocrystalline metal at least partially covering the polymer core and defining an outer structural surface of the vane.

There is further still provided, in accordance with another aspect of the present disclosure, a method of dynamically tuning a vane of a gas turbine engine compressor stator, the method comprising: providing a vane airfoil having a polymer core; and applying a coating of nanocrystalline metal onto the polymer core, the coating forming a nanocrystalline metal shell at least partially covering the polymer core, including varying a thickness of the nanocrystalline metal coating such as to provide regions of greater thickness and regions of lower thickness, the regions of greater thickness being selected such as to stiffen the vane and reduce expected deflections thereof during use.

### BRIEF DESCRIPTION OF THE DRAWINGS

Reference is now made to the accompanying figures in which:

FIG. 1 is a schematic cross-sectional view of a gas turbine engine;

FIG. 2 is a perspective view of a stator which can be used in a gas turbine engine such as that shown in FIG. 1;

FIG. 3 is a side perspective view of a vane of the stator of FIG. 2;

FIG. 4 is a cross-sectional view of the vane of FIG. 3; and

FIG. 5 is an exploded perspective view of an alternate stator which can be used in a gas turbine engine such as that shown in FIG. 1.

### DETAILED DESCRIPTION

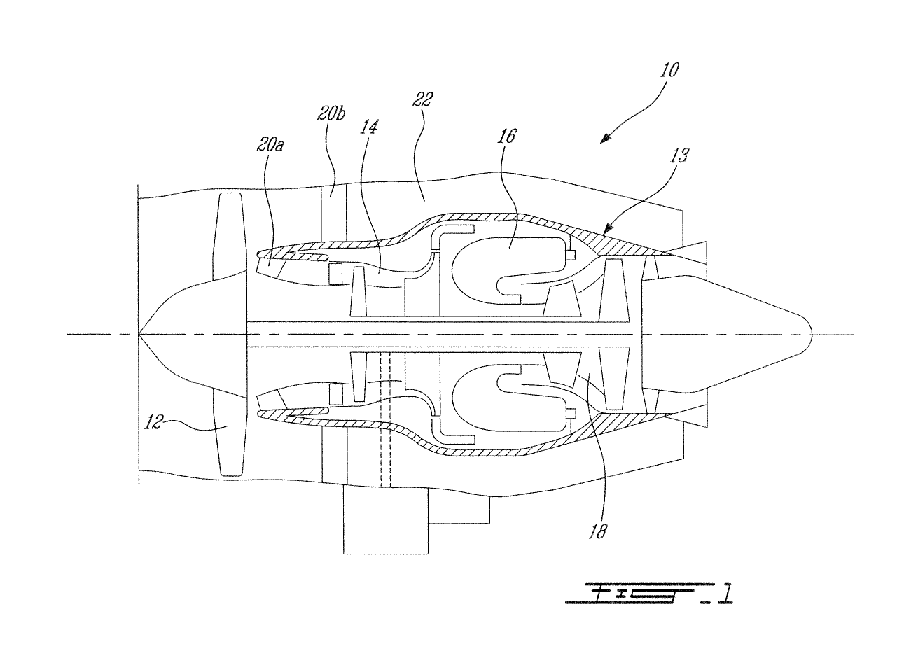

FIG. 1 illustrates a gas turbine engine 10 generally comprising, in serial flow communication, a fan 12 through which ambient air is propelled, an engine core gas path 13 including a compressor section 14 for pressurizing the air, a combustor 16 in which the compressed air is mixed with fuel and ignited for generating an annular stream of hot combustion gases, and a turbine section 18 for extracting energy from the combustion gases.

The engine also includes a core gaspath fan exit guide vane or stator 20a located downstream of the fan 12 and guiding the primary airflow towards the compressor section 14. The engine further includes a bypass duct 22 surrounding the core gaspath 13, and through which, part of the air propelled by the fan 12 is circulated, and a bypass fan exit stator 20b extending across the bypass duct 22 to guide the airflow therethrough.

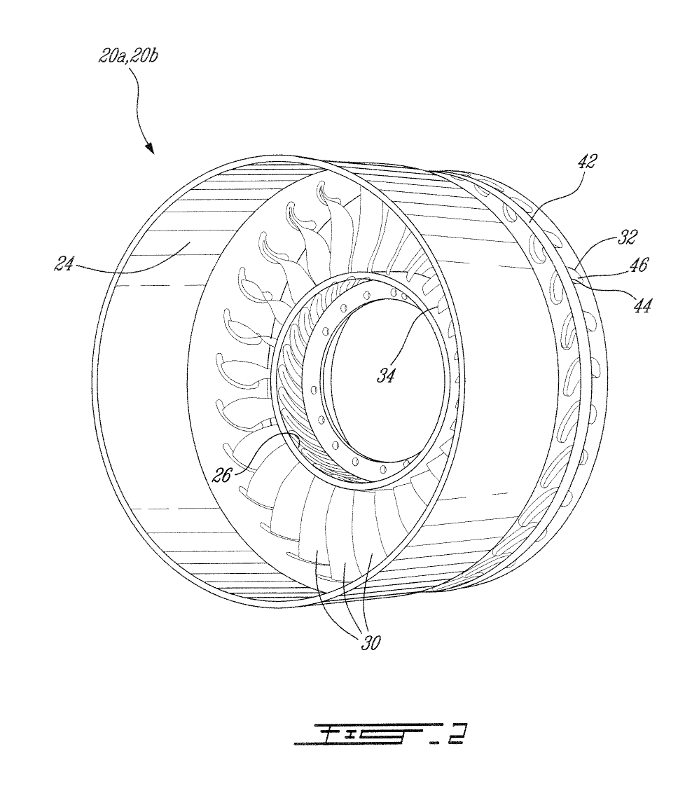

Referring to FIG. 2, an example of the stator 20a,20b is shown. In a particular embodiment, the stator 20a,20b corresponds to the core gaspath fan exit stator 20a or the bypass fan exit stator 20b. In an alternate embodiment, the stator may also be a stator or other airfoil of the compressor section 14. Alternatively still, the present teachings may be applied to any suitable gas turbine airfoil, whether fixed vanes airfoils or rotating blade airfoils, in the compressor section 14.

The stator 20a,20b includes an outer shroud 24 extending downstream or upstream of the blades of the fan or compressor, and an inner shroud 26 concentric with the outer shroud 24, the outer and inner shrouds 24, 26 defining an annular gas flow path there between. The outer shroud 24 can be part of or separate from, the casing of the engine 10. A plurality of vanes 30 extend radially between the outer shroud 24 and the inner shroud 26.

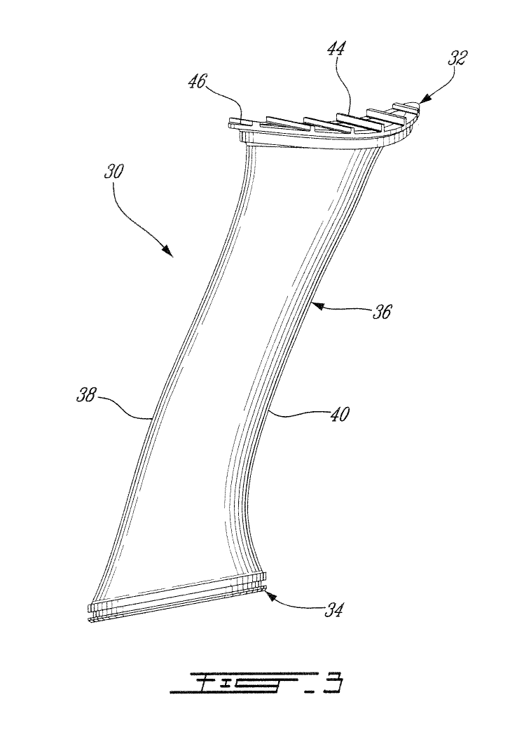

Referring to FIGS. 2-3, each of the vanes 30 has a vane root 32 retained in the outer shroud 24, a vane tip 34 retained in the inner shroud 26, and an airfoil portion 36 extending therebetween. The airfoil portion 36 of each vane 30 defines a relatively sharp leading edge 38 and a relatively sharp trailing edge 40, such that an airflow coming from the blades of the fan or compressor and passing through the stator 20a,20b flows over the vane airfoil 36 from the leading edge 38 to the trailing edge 40.

In the embodiment shown, the vanes are radially inserted into the outer shroud 24, and retained in place by a circumferential strap 42 (see FIG. 2) which is placed around the outer shroud 24 in aligned strap holders 44 defined in the outer surface 46 of the vane roots 32.

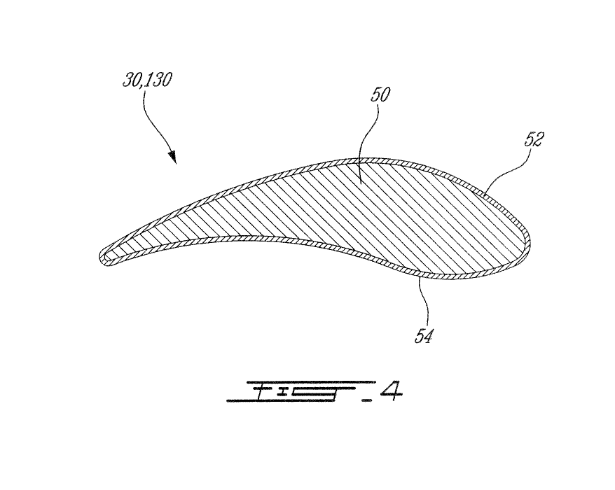

Referring to FIGS. 3 and 4, at least the airfoil portion 36 of each vane 30,130, but more particularly the entire vane 30, 130, is formed of a bi-material structure comprising a core 50 made of a non-metallic substrate material, such as a polymer for example, with a metallic outer coating or shell 52 which covers at least a portion the non-metal inner core, and which may in a particular embodiment fully encapsulates the polymer core. Accordingly, a “hybrid” vane airfoil is thus provided. In the present embodiment, the entire vane 30,130 is formed of the non-metallic core 50, which in at least this embodiment is formed of a polymer. For simplicity, the core 50 is illustrated here as being solid, although it is understood that the core 50 of the vane 30 can alternately be at least partially hollow and/or include heating, cooling or weight reduction channels or other openings defined therethrough. As will be seen in further detail below, the non-metallic core 50 of the vane 30,130 is at least partially covered (i.e. is either fully encapsulated or only partially coated) by a metallic top coat 52, which may be a single layer coating or a multiple layer coating composed of a nanocrystalline gain-sized metal (i.e. a nano-metal coating having a nano-scale crystalline structure—described herein) and/or other non-nanocrystalline metal coatings. Although the nanocrystalline metal outer coating may preferably be formed from a pure metal, as noted further below, in an alternate embodiment the nanocrystalline metal layer may also be composed of an alloy of one or more of the metals mentioned herein.

The polymer core 50 of the vane 30,130 may be manufactured by any suitable method, such as injection moulding, blow molding, forming or pressing, which may reduce manufacturing costs when compared to machining from aluminum. Accordingly, the polymer core 50 may be of a relatively low-grade polymer, which makes the molding and other fabrication process thereof relatively time and cost efficient. In a particular embodiment, the polymer substrate for the core 50 is a polyether ether ketone (PEEK), such as 450CA30 or 90HMF40, or a Nylon polymer (i.e. a polyamide), such as Durethan™ or 70G40. Examples of relatively high tensile strength polymers which may also be used for the non-metallic core 50 of the vanes are Vespel (a polyimide). Torlon, Ultem, etc.

It is understood that gas turbine vanes are typically long and slender, making dynamic resonance an issue if the vane is not sufficiently stiff. As well, the fan inlet and compressor vane must be able to withstand impact and foreign object damage (FOD), including so-called soft FOD caused by ice, hail, and the like. The skilled reader will also understand that the requirement to have a stiff vane for dynamics and deflection control under aerodynamic loading, while remaining tough enough to withstand FOD, is not currently attainable with conventional short fibre polymer technologies. Polymers such as PEEK are relatively brittle and can result in brittle fracture under FOD impact. Nylon or other such polymers are, on their own (i.e. without additional structural reinforcement), insufficiently stiff and/or rigid to satisfactorily perform as a gas turbine engine vane.

In order to provide adequate stiffness for the vane 30 formed of a polymer core 50, and in order to allow the vane 30 to be dynamically tuned (e.g. have a stiffness substantially comparable to a conventional solid aluminum vane), each vane 30 includes a single layer topcoat 52 of a nanocrystalline metal coating (i.e. a nano-scale metal coating) which at least partially covers or completely encapsulates the polymer core, as is illustrated in FIG. 4 with an exaggerated relative thickness of the topcoat 52 for clarity. Although multiple coats of the nanocrystalline metal may be applied to the polymer core if desired and/or necessary, in a particular embodiment the topcoat of the nanocrystalline metal is provided as a single layer, that is chemically bonded, such as by hybridization, to the substrate polymer core.

This nanocrystalline metal coating may be composed of a pure metal, such as Ni or Co for example. The metal topcoat 52 thus entirely encapsulates the polymer core 50 and defines the outer surface 54 of the vane 30. It is to be understood that the term “pure” as used herein is intended to include a metal comprising trace elements of other components. As such, in a particular embodiment, the nano metal topcoat 52 comprises a pure Nickel coating which includes trace elements such as, but not limited to: Carbon (C)=200 parts per million (ppm), Sulfur (S)<500 ppm, Cobalt (Co)=10 ppm, and Oxygen (O)=100 ppm.

While the topcoat 52 may be applied directly to the polymer substrate or core 50, in an alternate embodiment an intermediate bond coat may be first deposited on the substrate before the nanocrystalline metallic top coat is applied. The intermediate bond coat may improve bond strength and structural performance of the nanocrystalline metal coating 52 that otherwise may not bond well when coated directly to the substrate 50. In another embodiment, described for example in more detail in U.S. Pat. No. 7,591,745 which is incorporated herein by reference, a layer of conductive material may be employed between the polymer substrate 50 and the topcoat layer 52 to improve adhesion there between and therefore improve the coating process.

The nanocrystalline metal topcoat 52 forms an outer encapsulation layer which acts structurally to stiffen and strengthen the vane 30 sufficiently to allow it to perform comparably to a conventional solid metal vane typically used in aero gas turbine engine applications, thereby enabling the use of a “weak” (i.e. relative to aluminum) polymer core 50, which is cheaper, lighter weight, and/or easier to manufacture for the vane 30 than it is to form a standard vane out of solid aluminum.

The nanocrystalline metal top coat layer 52 has a fine grain size, which provides improved structural properties of the vane 30. The nanocrystalline metal coating is a fine-grained metal, having an average grain size at least in the range of between 1 nm and 5000 nm. In a particular embodiment, the nanocrystalline metal coating has an average grain size of between about 10 nm and about 500 nm. More preferably, in another embodiment the nanocrystalline metal coating has an average grain size of between 10 nm and 50 nm, and more preferably still an average grain size of between 10 nm and 15 nm.

The nanocrystalline metal topcoat 52 may be a pure metal such one selected from the group consisting of: Ag, Al, Au, Co, Cu, Cr, Sn, Fe, Mo, Ni, Pt, Ti, W, Zn and Zr, and is purposely pure (i.e. not alloyed with other elements) to obtain specific material properties sought herein. The manipulation of the metal grain size, when processed according to the methods described below, produces the desired mechanical properties for a vane in a gas turbine engine. In a particular embodiment, the pure metal of the nanocrystalline metal topcoat 52 is nickel (Ni) or cobalt (Co), such as for example Nanovate™ nickel or cobalt (trademark of Integran Technologies Inc.) respectively, although other metals can alternately be used, such as for example copper (Cu) or one of the above-mentioned metals. The nanocrystalline metal topcoat 52 is intended to be a pure nano-scale Ni, Co, Cu, etc. and is purposely not alloyed to obtain specific material properties. It is to be understood that the term “pure” is intended to include a metal perhaps comprising trace elements of other components but otherwise unalloyed with another metal.

In order to reduce the effects of thermal cycling on the vane, the selection of polymer for the core and metal for the coating may involve selecting a combination which minimizes differential thermal expansion between both materials. Additionally, the selection may be made to choose material combinations that have the highest bond strength. Doing so may assist in impeding the occurrence of debonding between the topcoat and the core.

The nanocrystalline metal topcoat 52 of nano-scale pure metal lowers the stress and deflection in the polymer core 50 when a load is applied. As the thickness of the topcoat 52 increases, the stress and deflection of the core 50 reduces. The stiffness of the polymer substrate material of the core 50 has a significant impact on the overall deflection and stress levels in the nanocrystalline metal metallic topcoat 52. It has been found that a weight-effective combination includes a relatively strong (i.e. relative to other polymers) polymer for the core 50 with a relatively thin nanocrystalline metal topcoat 52. The thickness of the single layer nanocrystalline metal topcoat 52 may range from about 0.001 inch (0.0254 mm) to about 0.125 inch (3.175 mm), however in a particular embodiment the single layer nano-metal topcoat 52 has a thickness of between 0.001 inch (0.0254 mm) and 0.008 inches (0.2032 mm). In another more particular embodiment, the nanocrystalline metal topcoat 52 has a thickness of about 0.005 inches (0.127 mm). The thickness of the topcoat 52 may also be tuned (i.e. modified in specific regions thereof, as required) to provide a structurally optimum part. For example, the nanocrystalline metal topcoat 52 may be formed thicker in expected weaker regions of the vane core 50, such as the leading edge 38, and thinner in other regions, such as the central region of the airfoil portion 36. The thickness of the metallic topcoat 52 may therefore not be uniform throughout the airfoil 36 or throughout the vane 30. This may be done to reduce critical stresses, reduce deflections and/or to tune the frequencies of the vane.

The nanocrystalline metal topcoat 52 can be applied to the polymer core 50 regardless of the complexity of the shape of the airfoil 36, and also allows the leading edge 38 to be very sharp, e.g. 0.001 inch thick (0.0254 mm), such as to minimize the boundary layer effect and as such may improve performance.

In a particular embodiment, the topcoat 52 is a plated coating, i.e. is applied through a plating process in a bath, to apply the fine-grained nanocrystalline metallic coating to the non-metallic substrate, such as to be able to accommodate complex vane geometries with a relatively low fabrication cost. Any suitable coating process can be used, such as for instance the plating processes described in U.S. Pat. No. 5,352,266 issued Oct. 4, 1994; U.S. Pat. No. 5,433,797 issued Jul. 18, 1995; U.S. Pat. No. 7,425,255 issued Sep. 16, 2008; U.S. Pat. No. 7,387,578 issued Jun. 17, 2008; U.S. Pat. No. 7,354,354 issued Apr. 8, 2008; U.S. Pat. No. 7,591,745 issued Sep. 22, 2009; U.S. Pat. No. 7,387,587 B2 issued Jun. 17, 2008 and/or U.S. Pat. No. 7,320,832 issued Jan. 22, 2008, the entire contents of each of which is incorporated herein by reference. Any suitable number of plating layers (including one or multiple layers of different grain size, and/or a larger layer having graded average grain size and/or graded composition within the layer) may also be provided. The nanocrystalline metal material(s) used for the topcoat 52 may include those variously described in the above-noted patents, namely U.S. Pat. No. 5,352,266, U.S. Pat. No. 5,433,797, U.S. Pat. No. 7,425,255, U.S. Pat. No. 7,387,578, U.S. Pat. No. 7,354,354, U.S. Pat. No. 7,591,745, U.S. Pat. No. 7,387,587, and U.S. Pat. No. 7,320,832, the entire content of each of which is incorporated herein by reference.

In an alternate embodiment, the metal topcoat layer 52 may be applied to the polymer core 50 using another suitable application process, such as by vapour deposition of the pure metal coating, for example. In this case, the pure metal coating may be either a nanocrystalline metal as described herein or a pure metal having more standard scale grain sizes.

If required or desired, the polymer substrate surface can be rendered conductive, e.g. by first coating the polymer surface with a thin layer of silver, nickel, copper or by applying a conductive epoxy or polymeric adhesive materials, prior to applying the encapsulating nanocrystalline metal topcoat layer(s). Additionally, the non-conductive polymer substrate may be rendered suitable for electroplating by applying such a thin layer of conductive material, such as by electroless deposition, physical or chemical vapour deposition, etc.

In a particular embodiment, the inner and outer shrouds 26, 24 of the stator 20a,20b (see FIG. 2) also include a core made of a polymer substrate covered by a single layer topcoat of the nanocrystalline pure metal which encapsulates the polymer core. The inner and outer shrouds 26, 24 may be of the same non-metallic substrate as the vane core 50 and the same nanocrystalline pure metal as the vane topcoat 52 of the previously described vanes 30, with similar characteristics, e.g. material, thickness, grain size, method of manufacture, etc.

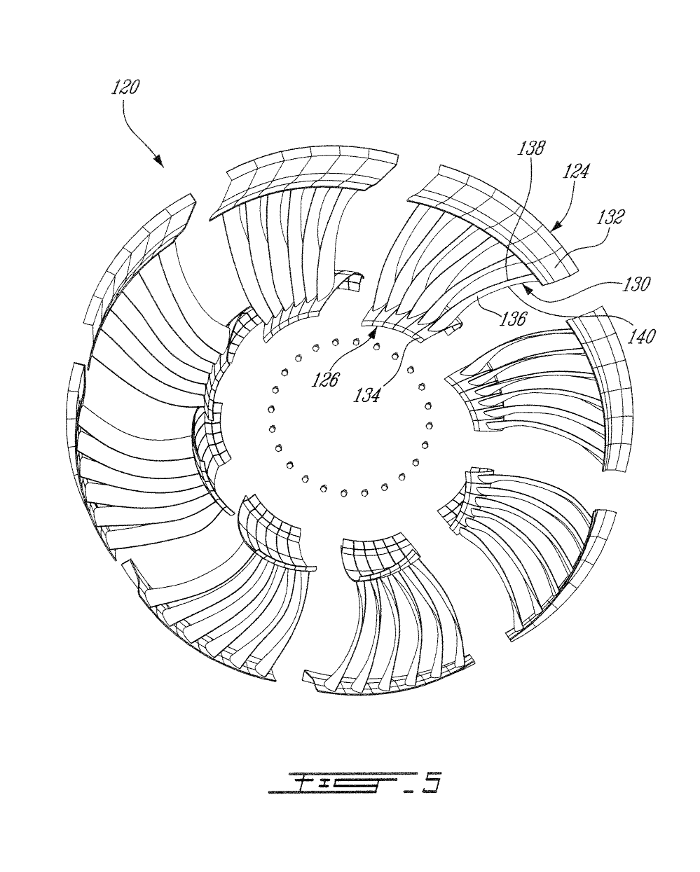

Referring now to FIG. 5, a stator 120 according to an alternate embodiment is shown. The stator 120 may be a core fan exit stator 20a or a bypass fan exit stator 20b, or alternately a stator of the compressor section 14 of the gas turbine engine 10. The stator 120 includes a plurality of individual vanes 130, each having a radially outer vane root 132, a radially inner vane tip 134, and an airfoil portion 136 extending therebetween. The airfoil portion 136 of the vanes 130 defines a relatively sharp leading edge 138 and a relatively sharp trailing edge 140. In this embodiment, each vane root 132 forms a respective part of the outer shroud 124, and each vane tip 134 forms a respective part of the inner shroud 126, such that the connected vanes 130 together define the inner and outer shrouds 124, 126, i.e. each vane includes inner and outer platforms integrally formed therewith which form a respective portion of the inner and outer shrouds 126, 124. The vanes 130 can be manufactured in groups of several vanes connected to an integral shroud portion as illustrated in FIG. 5, or as individual vanes (not shown).

As in the previous embodiment and as shown in FIG. 4, the vanes 130 are otherwise composed and configured as per the previously described vanes 30, and namely include a core 50 made of a non-metallic substrate, such as a polymer, which is at least partially covered, and more preferably encapsulated, by a single layer topcoat 52 of a nano-scale pure metal. Similar characteristics, e.g. material, thickness, grain size, method of manufacture, etc. as per the previously described embodiment nevertheless apply to the vanes 130, and as such will not be repeated here.

The metal topcoat 52 applied around the entirety of the stator vane 130 may be applied in any desired thickness, and either as a constant thickness or with a thickness which varies as a function of position on the stator (e.g. the coating thickness may be tuned to provide a structurally optimum part, such that it is thick in weaker regions of the part, such as the leading edge, and thinner in other regions requiring less reinforcement, such as the central airfoil region.

In another aspect of this embodiment, the molecules comprising the surface of the topcoat on the stator may be manipulated on a nanocrystalline scale to affect the topography of the final surface, such as to improve the hydrophobicity (i.e. ability of the surface to repel water) to thereby provide the stator with a superhydrophobic, self-cleaning surface which may beneficially reduce the need for anti-icing measures on the stator, and may also keep the airfoil cleaner, such that the need for a compressor wash of the airfoil is reduced.

In another embodiment, the polymer core 50 may have an at least partially hollow core body, and may for example be provided by welding two halves of a core body together to provide a hollow core.

Hence, it has been found that flightworthy vanes may be provided using alloy strength, low density polymer substrates having a nano-metallic topcoat, which may result in a significant cost advantage compared to a comparable carbon fibre composite vanes, or more traditional aluminum, steel or other metal vanes typically used in gas turbine engines. Accordingly, the present nano-metal coated polymer vanes may be cheaper to produce and lighter weight than traditional solid metal vanes, while nevertheless providing comparable strength and other structural properties, and therefore comparable if not improved life-span. For example, due to the improved resistance to foreign object damage (FOD) and erosion of the present nano-metal coated polymer vanes, reduced field maintenance of the gas turbine engine may be possible, as well as increased time between overhauls (TBO).

The topcoat 52 has mechanical properties which are superior to those of the substrate polymer. In effect, the topcoat provides a structural member which enables the use of a weaker substrate as the core. Additionally, the structural combination of the two materials may provide good impact resistance, which is desirable for resistance to so-called “soft” FOD caused by hail or other weather conditions, for example. Beneficially, the topcoat may also provide erosion protection to the vane, or at a minimum provide erosion resistance comparable to conventional aluminum vanes.

The properties and configuration of the combination of the metallic topcoat layer 52 and the polymer core substrate 50 may be selected to provide the resultant component with a stiffness similar to a conventional aluminum vane, and which would provide the vane with dynamic frequencies and resonances comparable to a conventional aluminum vane. By providing a “hybrid” (i.e. polymer core and metallic encapsulating topcoat) vane having dynamic properties comparable to known vanes, existing data on known full-metal vanes may be more easily extrapolated to the present vane design which may facilitate the designer in the prediction of vane performance, etc., and which may also therefore facilitate introduction of the new vane into a new production engine, or alternately as a field retrofit into an existing production engine.

In another embodiment, a conventional nickel coating (i.e. non-nanocrystalline) may be applied to a non-metal airfoil core, such as a polymer core, to provide a stator according to the present disclosure. The coating may be applied by plating, vapour deposition or any other suitable process, as described above.

A hybrid vane in accordance with the present disclosure, namely having a polymer core and a nanocrystalline metal shell, permits an overall vane that is between 10% and 40% lighter than a conventional solid aluminum vane of the same size. Further, while being more lightweight than such a comparable solid aluminum vane, the present hybrid vane also has an overall stiffness of between 50% and 110% of the stiffness of such a comparable solid aluminium vane, which allows for reduced permanent deflections, caused by ice and similar FOD impact for example. This may permit permanent deflections of the hybrid vane to be at least 50% lower, or equivalent (depending on such factors as the base polymer and the coating thickness), than such a corresponding solid aluminum vane of the same size and shape. Additionally, the polymer core that is encapsulated by a nanocrystalline metal shell permits the polymer core to be less sensitive to fluid exposure and therefore it is less likely that any degradation of the structural properties of the vane to occur.

The hybrid vane construction having a polymer core and a nanocrystalline metal shell may also provides a vane which is electrically conductive and thus which can be used as an engine grounding path. This may be particularly advantageous as the present hybrid compressor vane construction can thus provide sufficient electrical conductivity to permit being used as part of the engine's electrical grounding path, while still benefiting from the advantages noted herein associated with being formed of a non-metallic core (e.g. lower weight, etc.)

The presently described hybrid vane may also be formed such that it is at least partially hollow, i.e. the polymer core may comprises cavities therein which are adapted to receive a hot fluid or gas flow therein which may be used for example to providing anti-icing to the external surface of the vane, and the hybrid configuration (polymer core and nanocrystalline metal shell) of the present vane may accordingly enable a low-cost method of carrying a higher temperature fluid therein in comparison with solid aluminum vane airfoils.

Additionally, as noted above, the thickness of the nanocrystalline metal shell, which provides the structural integrity for the hybrid vane, may be adjusted and/or varied as required on the polymer core, for example in order to reduce stresses and stiffen the vane in order to reduce deflections in the vane and to dynamically tune the vane as required.

A stator vane according to the present teachings may also be employed in other suitable applications, including but not limited to, industrial gas turbine engines, auxiliary power units (APUs), and in other air handling systems, such as industrial cooling fan systems.

The above description is meant to be exemplary only, and one skilled in the art will recognize that changes may be made to the embodiments described without departing from the scope of the invention disclosed. For example, the vane may have any suitable configuration, such as individual insertable airfoils, a vane with integral inner and/or outer shrouds, a vane segment comprising a plurality of airfoils on a common inner and/or outer shroud segment, and a complete vane ring. The inner and/or outer shrouds may be manufactured separately (e.g. injection moulded and then coated) from the vanes, and then the individual insertable vanes are inserted into the shroud(s). Alternated, the entire stator may be integrally formed, such as by molding it from a polymer material and subsequently coating it with the selected metallic topcoat, nanocrystalline or otherwise, to form the stator with a polymer core encapsulated by the metallic topcoat. Any suitable polymer(s) and configuration may be used, and any suitable metal(s) may be selected for the topcoat. Any suitable manner of applying the topcoat layer may be employed. Still other modifications which fall within the scope of the present invention will be apparent to those skilled in the art, in light of a review of this disclosure, and such modifications are intended to fall within the appended claims.

1. A compressor stator for a gas turbine engine, the stator comprising:
a plurality of hybrid vanes each including an airfoil extending between a vane root and a vane tip; and
each of the hybrid vanes having a core of a non-metallic substrate at least partially covered by a nanocrystalline metal shell the nanocrystalline metal shell defining an outer surface of the vane.

2. The compressor stator as defined in claim 1, wherein the core of said non-metallic substrate is fully encapsulated by the nanocrystalline metal shell

3. The compressor stator as defined in claim 1, further comprising an annular outer shroud, an annular inner shroud located inwardly of and concentric with the outer shroud, and wherein the inner and outer shrouds also have a core formed of the non-metallic substrate that has a topcoat of the nanocrystalline metal thereon.

4. The compressor stator as defined in claim 1, wherein the non-metallic substrate is a polymer.

5. The compressor stator as defined in claim 4, wherein the polymer includes one or more of a polyamide or a polyimide.

6. The compressor stator as defined in claim 1, wherein the nanocrystalline metal is a pure metal.

7. The compressor stator as defined in claim 6, wherein the pure metal is selected from the group consisting of: Ni, Co, Ag, Al, Au, Cu, Cr, Sn, Fe, Mo, Pt, Ti, W, Zn, and Zr.

8. The compressor stator as defined in claim 6, wherein the pure metal is nickel or cobalt.

9. The compressor stator as defined in claim 1, wherein the nanocrystalline metal shell has a thickness of between 0.001 inch and 0.008 inch.

10. The compressor stator as defined in claim 9, wherein the thickness of the nanocrystalline metal shell is about 0.005 inch.

11. The compressor stator as defined in claim 1, wherein a thickness of the nanocrystalline metal shell is non-constant throughout the vane.

12. The compressor stator as defined in claim 11, wherein the thickness of the nanocrystalline metal shell is greater along at least one of a leading edge and a trailing edge of the airfoil than along a central portion of the airfoil disposed between the leading edge and trailing edge.

13. The compressor stator as defined in claim 1, wherein the nanocrystalline metal has an average grain size of between 10 nm and 500 nm.

14. The compressor stator as defined in claim 13, wherein the average grain size of the nanocrystalline metal is between 10 nm and 15 nm.

15. The compressor stator as defined in claim 1, wherein the nanocrystalline metal shell is in direct contact with the non-metallic substrate.

16. The compressor stator as defined in claim 1, wherein an outer surface of the nanocrystalline metal shell has a hydrophobic-causing topography.

17. The compressor stator as defined in claim 1, wherein the nanocrystalline metal shell is a topcoat of the nanocrystalline metal formed as a single layer, the single layer of the nanocrystalline metal being chemically bonded to the non-metallic substrate of the core.

18. The compressor stator as defined in claim 1, wherein one or more fluid-receiving cavities extend within the non-metallic substrate of the airfoil such that the hybrid vane is at least partially hollow.

19. The compressor stator as defined in claim 1, wherein the hybrid vane has an overall stiffness of between 50% and 110% of the stiffness of a corresponding solid aluminum vane having the same size and shape.

20. The compressor stator as defined in claim 1, wherein the hybrid vane is electrically conductive, the electrically conductive vane providing an engine grounding path through the compressor stator.

21. A hybrid vane airfoil for a compressor stator in gas turbine engine, the hybrid vane airfoil comprising a bi-material structure having a polymer core that is encapsulated by a metallic shell defining an outer surface of the vane, the metallic shell having at least an outer surface entirely composed of a nanocrystalline metal having an average grain size of between 10 nm and 500 nm, and the metallic shell having a thickness of between 0.001 inch and 0.008 inch.

22. A method of manufacturing a vane for a gas turbine engine, comprising:
forming a non-metallic airfoil out of a polymer, to form a polymer core; and
applying a coating of nanocrystalline metal onto the polymer core, the nanocrystalline metal at least partially covering the polymer core and defining an outer structural surface of the vane.

23. The method as defined in claim 22, wherein the step of applying the layer of nanocrystalline metal includes plating the nanocrystalline metal onto the polymer core.

24. The method as defined in claim 22, wherein the step of plating the nanocrystalline metal includes plating a single layer of nano-scale pure nickel or cobalt.

25. The method as defined in claim 22, wherein the step of forming further comprises injection molding the polymer core.

26. The method as defined in claim 22, wherein the step of applying further comprises fully encapsulating the polymer core with the nanocrystalline metal coating.

27. A method of dynamically tuning a vane of a gas turbine engine compressor stator, the method comprising: providing a vane airfoil having a polymer core; and applying a coating of nanocrystalline metal onto the polymer core, the coating forming a nanocrystalline metal shell at least partially covering the polymer core, including varying a thickness of the nanocrystalline metal coating such as to provide regions of greater thickness and regions of lower thickness, the regions of greater thickness being selected such as to stiffen the vane and reduce expected deflections thereof during use.
